(19) United States
(12) Patent Application Publication
(10) Pub. No.: US 2013/0003732 A1
(43) Pub. Date: Jan. 3, 2013

(54) ABSTRACTING ACCEPTING INTERFACE TO OPTIMIZE PARENT AND CHILD ENTRY LOOKUP FOR BIDIRECTIONAL PIM

(75) Inventors: Mehul Harshad Dholakia, Cupertino, CA (US); Wing-Keung Adam Yeung, Pleasanton, CA (US)

(73) Assignee: BROCADE COMMUNICATIONS SYSTEMS, INC., San Jose, CA (US)

(21) Appl. No.: 13/231,367

(22) Filed: Sep. 13, 2011

Related U.S. Application Data
(60) Provisional application No. 61/502,692, filed on Jun. 29, 2011.

(51) Int. Cl. H04L 12/56

(52) U.S. Cl. 370/390

(57) ABSTRACT

During operation the system identifying a multicast address in a packet. The system then determines a first entry in a first table, wherein the first entry maps a multicast group prefix and an accepting interface to a first logical reference. The system then determines a second entry in a second table, wherein the second entry maps the first logical reference and a multicast group address to forward packets to one or more forwarding interfaces.

### RELATED APPLICATION

This application claims the benefit of U.S. Provisional Application No. 61/502,692, Attorney Docket Number BRCD-3026.1.US.PSP, entitled “PIM-BIDIR DESIGN,” by inventors Wing-Keung Adam Yeung and Mehul Harshad Dholakia, filed 29 Jun. 2011.

### BACKGROUND

1. Field

This disclosure is generally related to communication networks. More specifically, this disclosure is related to a switch architecture that can facilitate scalable and efficient bidirectional multicast.

2. Related Art

A conventional multicast network operating in Protocol-Independent Multicast Sparse-Mode (PIM-SM) typically uses a unidirectional shared tree to deliver multicast payload from a source to a plurality of recipient of a multicast group. A designated router (DR) may join or leave the multicast group by sending “join” or “prune” messages toward a rendezvous point (RP) of the multicast group. When a recipient joins a multicast group, all the routers along the data path from the recipient to the RP would also join the group and create a wild card route entry (*, g) for forwarding traffic for the multicast group. The wildcard character “*” represents any source, and the character “g” corresponds to the multicast group. The (*, g) entry specifies the group address, the incoming interface (IIF) corresponding to the RP from which packets are accepted, and a list of outgoing interfaces (OIFs) corresponding to downstream recipients to which packets are sent. It is also possible for a router to create an (s, g) routing entry to create a source tree, which corresponds to a shortest-path route from the source.

If the network operates in Protocol-Independent Multicast Bidirectional Mode (PIM-BIDIR), a router may maintain multiple (*, g) child entries under the same (*, g/m) parent entry, where they all share the same incoming interface. A conventional forwarding table still stores these forwarding entries separately for each multicast group address, although these entries essentially have the same content. This configuration results in inefficient usage of the multicast forwarding tables. In addition, this solution is difficult to scale for a large number of multicast groups.

### SUMMARY

One embodiment provides a switching system. During operation the system identifying a multicast address in a packet. The system then determines a first entry in a first table, wherein the first entry maps a multicast group prefix and an accepting interface to a first logical reference. The system then determines a second entry in a second table, wherein the second entry maps the first logical reference and a multicast group address to one or more forwarding interfaces.

In a variation on this embodiment, the system determines the first entry by performing a lookup in the first table based on an accepting interface corresponding to the packet.

In a further variation, the system determines the first entry by performing a lookup in the first table based on a multicast group prefix address range corresponding to the packet.

In a variation on this embodiment, the system determines whether the forwarding interface is the same as the accepting interface.

In a variation on this embodiment, the system determines the forwarding interface by selecting at least one destination address for the packet from a third table based on the group address.

In a variation on this embodiment, the system inserts a third entry into the first table, such that the third entry indicates routing state information of a rendezvous point (RP) and a second logical reference unique to the RP.

In a further variation, the system determines a reverse-path forwarding (RPF) interface for the RP.

In a variation on this embodiment, the system designates a routing node in the network as a designated-forwarder (DF) for an interface of the RP.

In a variation on this embodiment, the system stores state information for the multicast group and the first logical reference.

### BRIEF DESCRIPTION OF THE FIGURES

FIG. 1 illustrates an exemplary network architecture which facilitates PIM-BIDIR in accordance with an embodiment.

FIG. 2 presents a flow chart illustrating a process for facilitating PIM-BIDIR forwarding in accordance with an embodiment.

FIG. 3 illustrates data structures for storing RP and multicast group PIM-BIDIR forwarding states in accordance with an embodiment.

FIG. 4 presents a flow chart illustrating a process for creating an entry corresponding to an RP in a parent lookup table in accordance with an embodiment.

FIG. 5 presents a flow chart illustrating a process for creating an entry corresponding to a multicast group address in a child lookup table in accordance with an embodiment.

FIG. 6 illustrates an example interface configuration in a network that facilitates PIM-BIDIR in accordance with an embodiment.

FIG. 7 presents a flow chart illustrating a process for forwarding a multicast packet in accordance with an embodiment.

FIG. 8 illustrates an exemplary router architecture in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of constructing an efficient, scalable PIM-BIDIR forwarding table by utilizing two lookup tables to facilitate a two-tier lookup structure. The first lookup table stores entries that are specific to input interfaces and RP's, and provides a logical reference as the lookup output corresponding to a given RP (multiple input interfaces associated with the same RP are mapped to the same logical reference). This logical reference is then used to search the second lookup table, which stores entries specific to each multicast group address. In this way, for packets which are associated with different multicast group addresses (but have the same RP), and which arrive on the same incoming interface, there is only one entry in the first lookup table. This configuration can significantly reduce the lookup table size for PIM-BIDIR.

For example, the first lookup table may include several entries for an RP, each entry corresponding to an accepting interface for that RP. A respective entry maps to a logical reference. In the second lookup table, a logical reference and a specific multicast group address form an entry. The lookup result of the second lookup table points to the outgoing interfaces to which the arriving packet should be sent. Hence, by using a logical reference per RP/incoming interface combination, the system can save a significant amount of storage space in the lookup table.

This PIM-BIDIR router architecture provides a scalable design that requires fewer lookup entries to be created than if a single conventional lookup table was used to perform PIM-BIDIR. For example, to build a PIM-BIDIR network using a conventional lookup configuration, the conventional router would need to store, for each multicast group address, a forwarding entry that maps this group to a respective accepting interface. Thus, for M multicast groups that each map to a total of N accepting interfaces, a conventional router would need to store M×N routing entries in the single lookup table. In contrast, the PIM-BIDIR forwarding table configuration disclosed herein can store an equivalent amount of mapping by creating N entries in the first lookup table for the RP input interfaces, and creating M entries in the second lookup table for the multicast group addresses. As a result, there are only M+N entries in total.

While the remainder of this disclosure presents an example implementation for PIM-BIDIR, the methods and apparatus described herein may apply to any bidirectional multicast routing techniques now known or later developed.

### Exemplary Network Architecture

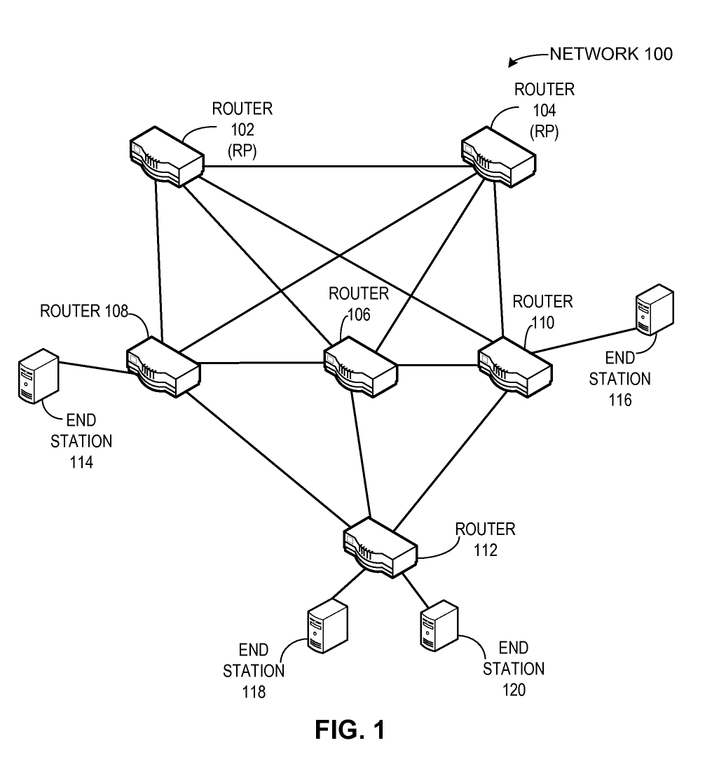

FIG. 1 illustrates an exemplary network architecture which facilitates PIM-BIDIR in accordance with an embodiment. Network 100 can include routers 102, 104, 106, 108, 110, and 112 configured to form a multicast network topology. Further, network 100 can include end stations 114, 116, 118, and 120 that can join a multicast group. Specifically, any of end stations 114-120 can be a sender for the multicast group, and routers 102-112 can replicate packets from any sender to other members of the multicast group.

For a respective multicast group, one of the routers is selected to be the corresponding RP. This RP designation is typically provisioned by a network administrator when a multicast group is formed. In the example illustrated in FIG. 1, routers 102 and 104 are RP's for their respective multicast groups. When a PIM-BIDIR multicast group is formed, every router within that group also initiates a default forwarding state for that group. This process involves two operations. First, each router identifies one of its interfaces as the reverse path forwarding (RPF) interface, which is the interface corresponding to the shortest path to the RP. The router designates this RPF interface as a permitted input (accepting) interface (designated with an “A,” which means “accepting”), and as a permitted output (forwarding) interface (designated with an “F,” which means “forwarding). In addition, for a given multicast group, a designated forwarder (DF) election is performed for each link by the two routers coupled to the two ends of the link, wherein the router closer to the RP is elected to be the DF (i.e., a DF election winner). On a given router, each interface that is a DF election winner would be an accepting interface (designated as “A”) for that multicast group. If a DF-winner interface receives a (*, g) join message, this interface would be both an accepting and forwarding interface (designated as both “A” and “F”) for that multicast group. The above process occurs when the multicast group is formed and as a result it generates a default forwarding state in every router that belongs to the PIM-BIDIR group.

When a multicast receiver joins a multicast group, the link between the host and its first-hop router elects a DF (which is the router). Furthermore, a (*, g) forwarding state is created (or updated if the router is already in that multicast group) to include the forwarding information corresponding to the router interface coupled to that host. This (*, g) state is then merged with the default routing state previously created when the multicast group was formed.

Any of end stations 114-120 that has joined the multicast group can send packets to the multicast group. For example, end station 114 can send a packet to the multicast group through its first-hop router 108. Router 108 can then use the entries in the first and second lookup tables, which jointly match the packet's incoming interface, the RP, and the multicast group address to determine a number of forwarding interfaces for the packet. More details about PIM-SM and PIM-BIDIR can be found in IETF RFC 4601 (available at http://tools.ietf.org/html/rfc4601) and RFC 5015 (available at http://tools.ietf.org/html/rfc5015), both are incorporated by reference in their entirety herein.

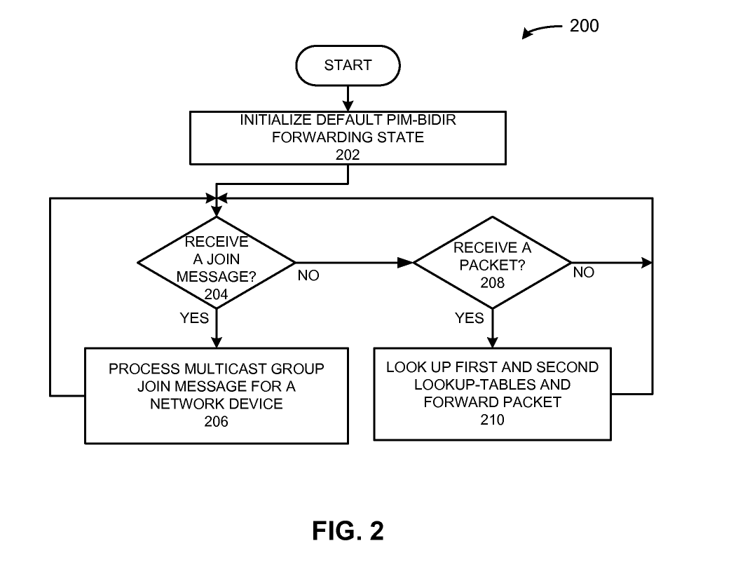

FIG. 2 presents a flow chart illustrating a process 200 for facilitating PIM-BIDIR forwarding in accordance with an embodiment. During operation, a router initializes its default PIM-BIDIR forwarding state based on the multicast group and RP configuration (operation 202). For example, in a subnet, one RP might be designated for all 224.0.0.0/4 multicast group addresses. Correspondingly, the router would populate a default PIM-BIDIR forwarding state based on its interface toward the RP (which would be an “A” or accepting interface, meaning that multicast packets arriving from that interface from the RP are allowed), and a DF-election process on all other interfaces (that is, if an interface is designated as a DF for the corresponding link, that interface is designated as both an “A” (accepting) interface and “F” (forwarding) interface).

In some embodiments, the router can perform operation 202 using a bootstrap protocol that automatically (e.g., without human intervention) detects one or more of RPs, and determines the default PIM-BIDIR forwarding state for each RP. Also, the router can perform operation 202 in response to a user (e.g., a network administrator) accessing a configuration command line interface (CLI) of the router. The router can create one or more entries in a first lookup table to store the default forwarding state. Each of these entries includes an interface identifier (IFid) for an accepting interface of the router, a bidirectional multicast address range corresponding to an RP (hereinafter referred to as a BIDIR range), and a logical interface identifier (LIFid) that is unique to the BIDIR range (and the RP). These entries in the first lookup table are hereinafter referred to as parent entries.

After the default PIM-BIDIR forwarding state is initialized, the router can continue to process multicast group join messages from multicast receivers. For example, if the router receives a multicast group join message (operation 204), the router can process the join message to create one or more entries in a second lookup table to store a forwarding state for the multicast group (operation 206). Each of these entries includes a LIFid that associates the RP's BIDIR range and a multicast group address (which is within the BIDIR range). This entry for the multicast group is hereinafter referred to as a child entry, as it uses the LIFid to reference parent entries for a BIDIR range in the first lookup table. In some embodiments, the router can store a plurality of forwarding interfaces for the multicast group in a non-volatile storage (e.g., a phase-change random access memory, or PRAM), such that these forwarding interfaces can be accessed based on a pointer stored in an entry in the second lookup table.

Thus, the first lookup table stores parent PIM-BIDIR default forwarding-state entries that are specific to an incoming interface and RP (but not specific to individual multicast group addresses). The second lookup table stores child state entries which associate an RP with different group addresses and are used for forwarding traffic via specific output interfaces.

If the router receives a data packet (operation 208), the router first looks up the first lookup table based on the packet's input interface and the RP corresponding to the packet's multicast group address. This first lookup results in a logical reference, which is subsequently used to look up the second lookup table in combination with the packet's multicast group address. The second lookup produces a pointer to the PRAM which stores the identifiers of the forwarding interfaces to which the packet is sent (operation 210). The router can return to operations 204 or 208 to process other join messages or data packets.

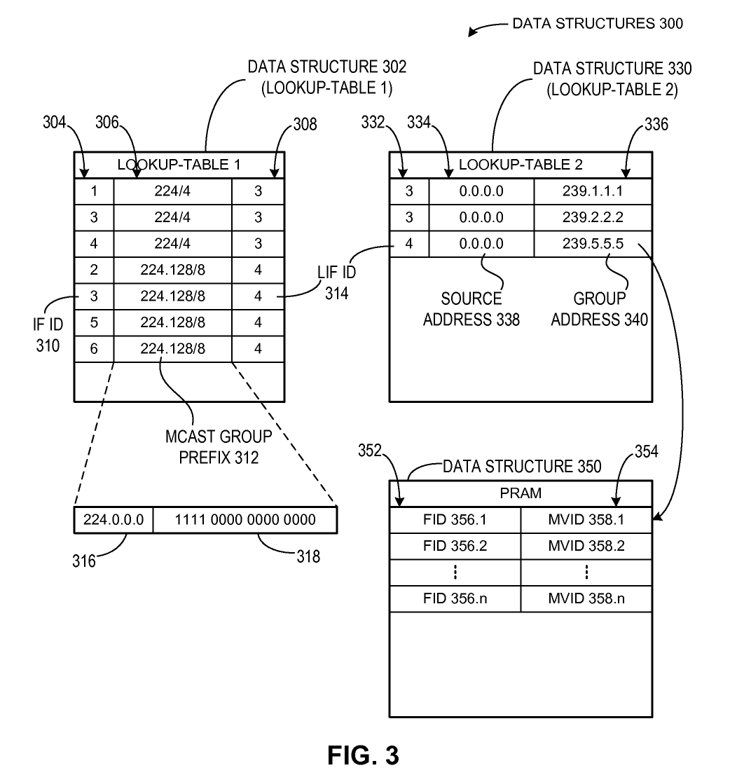

FIG. 3 illustrates data structures 300 for storing RP and multicast group PIM-BIDIR forwarding states in accordance with an embodiment. Data structures 300 may include a first lookup table 302 for storing a plurality of RP and input interface-specific entries, and a second lookup table 330 for storing multicast group address-specific entries. Lookup tables 302 and 330 are hereinafter referred to as lookup-table 1 and lookup-table 2, respectively.

Data structures 300 may also include a non-volatile data structure 350 for storing information identifying the forwarding interface(s) for a multicast group addresses. Data structure 350 may, for example, include a PRAM storage and is hereinafter referred to as PRAM.

Lookup-table 1 includes a column 304 for storing accepting interface identifiers (also referred herein as IFid) for each RP, and a column 306 for storing multicast group prefix information for the one or more RPs (e.g., MCAST GROUP PREFIX 312, which corresponding to a BIDIR range). Further, lookup-table 1 may include a column 308 for storing logical interface identifiers for the one or more multicast prefixes. A logical interface identifier (also referred to herein as LIFid, or as a logical reference) is unique to a single multicast prefix, and may be used in a lookup-table 2 entry to associate a multicast group address with the BIDIR address range.

In some embodiments, multicast group prefix 312 and group address 340 correspond to a Class D network address, which includes an address range reserved for multicast addressing. In a Class D network address, the four leading bits are set to 1110, which results in an address range that begins at 224.0.0.0, and ends at 239.255.255.255. For example, multicast group prefix 312 indicates a base address for the complete class D multicast addressing range. As another example, multicast group prefix 312 can be configured to indicate a reduced range that falls within a subset of the Class D addressing range (e.g., a prefix value 224.128/8).

For example, an RP in the network may be assigned a LIFid value of 3, and may have three corresponding accepting interfaces, which have been assigned IFid values 1, 3, and 4 under column 304. Note that these accepting interfaces are derived at the initialization stage when the RP is designated. Further, this RP corresponds to a multicast group prefix of 224/4 under column 306 (meaning that any multicast group whose address falls within this range would use this RP). A second RP in the network may be assigned a LIFid value of 4, and may have four accepting interfaces, which have been assigned IFid values 2, 3, 5 and 6 under column 304. In addition, the lookup-table 1 entries for the second RP may be assigned a multicast group prefix of 224.128/8 under column 306. Note that during a lookup, the system performs a longest match in lookup-table 1. Therefore, when a packet's multicast group address matches both 224/4 and 224.128/8, the lookup produces a LIF ID value of 4.

In one embodiment, the multicast group prefix (e.g., prefix 312) may include a bitmap with two fields (e.g., fields 316 and 318). Field 316 may include a base address for multicast group prefix 312, and field 318 may include a bitmask for multicast group prefix 312. By default, the BIDIR range can be 224/4, for example if an ACL is not specified. In some embodiments, column 308 includes a plurality of 12-bit fields for storing LIFid values. Thus, column 308 provides storage for 4096 unique LIFids, thus supporting 4096 unique BIDIR ranges.

The router can determine if a network address falls within the BIDIR range defined by prefix 312 by applying the bitmask from field 318 to the network address (e.g., using a bitwise-AND operation), and comparing the result to the base address from field 316. If the resulting address matches the base address, then the network address is known to fall within the BIDIR range provided by multicast group prefix 312.

Lookup-table 2 may include a column 332 for storing a LIFid corresponding to an RP's BIDIR range, and may also include a column 336 for storing a multicast group address. Thus, if an RP is associated with one or more multicast groups, lookup-table 2 may include entries that map the LIFid for the RP's address range (e.g., LIF ID 314) to the one or more group addresses (e.g., group address 340).

Further, lookup-table 2 may store entries for a variety of multicast routing schemes. For example, lookup-table 2 may include a column 334 for storing a source address, which may be used to indicate the source address for a unidirectional multicast routing scheme (e.g., PIM-SM). This source address may correspond to the sender of the multicast group. However, when an entry in lookup-table 2 corresponds to a bidirectional multicast group address (e.g., PIM-BIDIR, which supports multicast packets from multiple senders), this entry in lookup-table 2 may indicate a wildcard address (e.g., 0.0.0.0) for the sender.

Data structure 350 can include a column 352 which indicates the output interface ID (FID), and a column 354 which indicates a Multicast VLAN ID (MVID). The FID contains a pointer (e.g., pointers 356.1, 356.2, . . . , 356.n) that references a table storing identifiers for one or more interfaces, which can be used to determine the output interfaces to which a received packet is to be sent. The corresponding MVID values (e.g., values 358.1, 358.2, . . . , 358.n) indicate the appropriate VLAN values to be assigned to the outgoing packets.

### Creating a Parent Entry

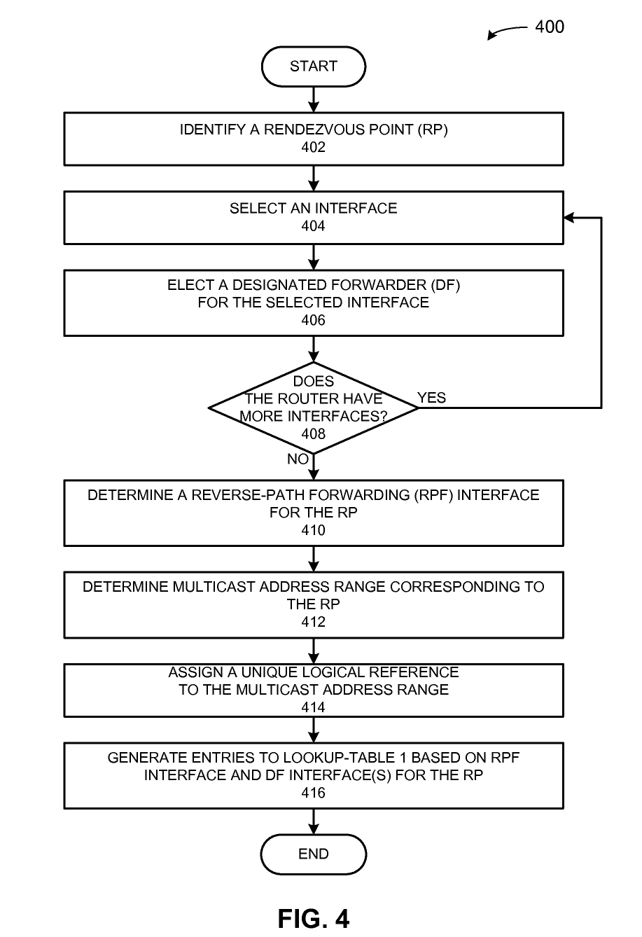

FIG. 4 presents a flow chart illustrating a process for creating an entry corresponding to an RP in a parent lookup table in accordance with an embodiment. During operation, the router identifies an RP (operation 402). The router then elects a designated forwarder (DF) for router interfaces.

To perform DF election, the router selects a router interface (operation 404), and elects a designated forwarder (DF) corresponding to the RP for the router's selected interface (operation 406). If the selected interface is elected to be a DF, this interface is marked as an accepting interface for the RP. (Note that if the interface is not elected as the DF, this interface cannot accept incoming multicast packet corresponding for this RP.) The router then determines whether the router has more interfaces (operation 408). If so, the router returns to operation 404 to elect another DF for another router interface. If the router determines at operation 408 that there is no other interface that has not gone through the DF-election process, the router can continue to determine a reverse-path forwarding (RPF) interface for the RP (i.e., the interface corresponding to the shortest path leading to the RP) (operation 410). This RPF interface is also marked as an accepting interface for the RP.

Next, the router determines a multicast address range corresponding to the RP (operation 412). The router also assigns a logical interface ID (LIFid) to the RP (operation 414). The LIFid serves as a logical reference to the RP, and is used to associate the RP's BIDIR range in lookup-table 1 to entries in lookup-table 2 for one or more multicast group addresses.

The router then generates entries to lookup-table 1 based on all the interfaces that have been marked as accepting interfaces for the RP (operation 416). Each entry specifies the accepting interface identifier (see column 304 in FIG. 3), the multicast address range for the RP (see column 306 in FIG. 3), and the LIFid corresponding to the RP (see column 308 in FIG. 3).

When a multicast receiver joins the multicast group, a corresponding (*, g) entry is also created in lookup-table 2. This entry shares the same LIFid as the parent (*, g/m) entry, since it shares the same incoming interface as the parent.

### Creating Lookup-Table 2 Entries

In some embodiments, the router creates a child entry in lookup-table 2 for a multicast group when it receives PIM join messages from downstream routers or an IGMP join message from a multicast receiver. The child entry represents a group interest that is initiated from a PIM last hop router. The child entry stores routing state information that is used to deliver multicast data from the packet sources and RPs to receivers of the multicast group. A child entry inherits accepting and forwarding interfaces from an RP (e.g., a parent entry in lookup-table 1), which can be determined based on the LIFid for the child entry. The immediate forwarding interfaces for a child entry are the interfaces corresponding to the join messages that the router receives, which can be accessed from the PRAM storage based on the multicast group address.

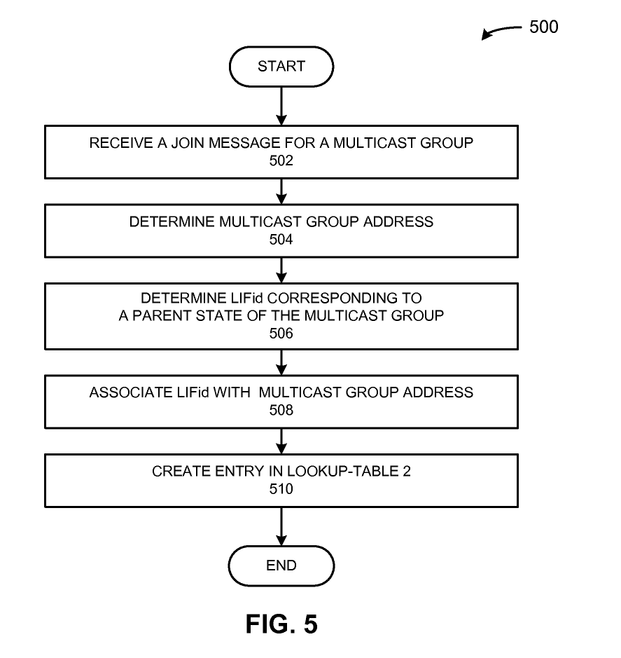

FIG. 5 presents a flow chart illustrating a process for creating an entry corresponding to a multicast group address in a child lookup table in accordance with an embodiment. During operation, the router can receive a join message for a multicast group, either from a downstream router or a multicast receiver (operation 502). The router then determines a multicast group address.

Then, the router determines a LIFid corresponding to a parent state of a multicast group based on the accepting interface and the address range of the multicast group address carried in the packet (operation 506). During operation 506, the router determines a (*, g/m) parent state corresponding to the (*, g) child state of the multicast group address, and determines the LIFid from the (*, g/m) parent state. The LIFid is copied from the (*, g/m) state to the (*, g) state. The router then associates the LIFid with the packet's multicast group address (operation 508). The router then generates a child entry in lookup-table 2 which includes the LIFid and the multicast group address (operation 510). The generated entry also includes a pointer to the PRAM which points to an identifier of the interface on which the join message arrives. This interface is the forwarding (output) interface for subsequent multicast packets.

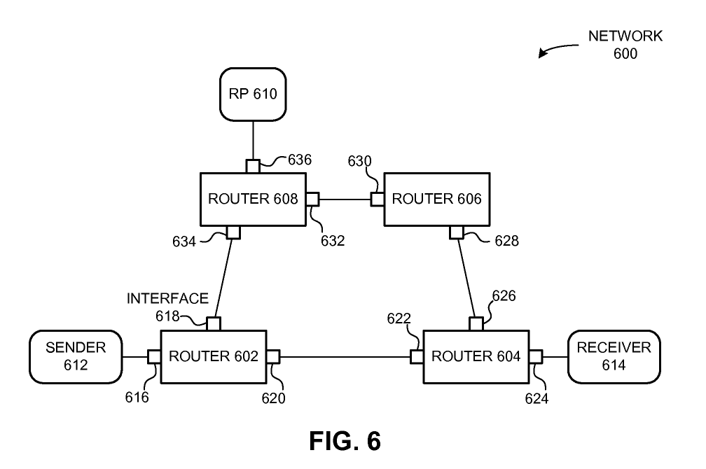

FIG. 6 illustrates an example interface configuration in a network that facilitates PIM-BIDIR in accordance with an embodiment. In this example, a network 600 includes routers 602, 604, 606, 608, and an RP 610. Further, network 600 can include a sender 612 and a receiver 614.

Assume that routers 602 and 604 are placed in a multicast group, and RP 610 can be a router upstream to routers 606 and 608. The sender is behind router 602, and the receiver is behind router 604. Routers 602 has a better routing metric toward RP 610 than router 604 (e.g., router 602 is closer to RP 610 than router 604), and thus router 602 is the DF winner for the link between router 602 and router 604.

TABLE 1

| | Router | Router | Router | Router |
|---|---|---|---|---|
| | 602 | 604 | 606 | 608 |
| (*, g/m) | | | | |
| IIF | 616, 618, 620 | 622, 624 | 628, 630 | 632, 634, 636 |
| (Accepting) | | | | |
| OIF | 618 | 622 | 630 | 636 |
| (Forwarding) | | | | |
| (*, g) | | | | |
| immediate-IIF | | | | |
| immediate-OIF | 620 | 624 | | 634 |

Table 1 illustrates the interface designation for the routers in network 600. When routers 602-608 are configured, the parent entries (i.e., the (*, g/m) routing state) for each are configured as follows. For router 602, DF is elected on interfaces 616 and 620. Hence, these interfaces are marked as accepting interfaces. Interface 618 is the RFP interface for RP 610. Hence, interface 618 is marked as both accepting and forwarding interface. For router 604, DF is only elected on interface 624, which is marked as an accepting interface. Interface 622 is the RFP interface for RP 610 and is therefore marked as both accepting and forwarding interface. For router 606, DF is elected on interface 628, which is marked as an accepting interface. Interface 630 is the RFP interface for RP 610, and is hence marked as both accepting and forwarding. For router 608, interfaces 632 and 634 are elected DF interfaces and hence are both accepting interfaces. Interface 636 is the RFP interface for RP 610 and hence is marked as both accepting and forwarding.

When receiver 614 joins the multicast group, routers 604, 602, and 608 propagate the join message with a non-empty OIF upstream through network 600 toward RP 610. These join messages allow the routers along the data path to create child entries (i.e., the (*, g) routing state, corresponding to an immediate outgoing interface) that may be used to reach receiver 614. For example, router 602 receives a join message from router 604 via accepting interface 620, and so it configures accepting interface 620 as the forwarding interface. Similarly, router 608 receives a join message from router 602 via accepting interface 634, and it configures accepting interface 634 as the forwarding interface.

### Packet Processing

In general, a router can use the incoming interface and the destination address (which in is a multicast group address) of a received multicast packet to perform a lookup in lookup-table 1 to determine the LIFid, and then performs a lookup in lookup-table 2 to determine the forwarding interfaces.

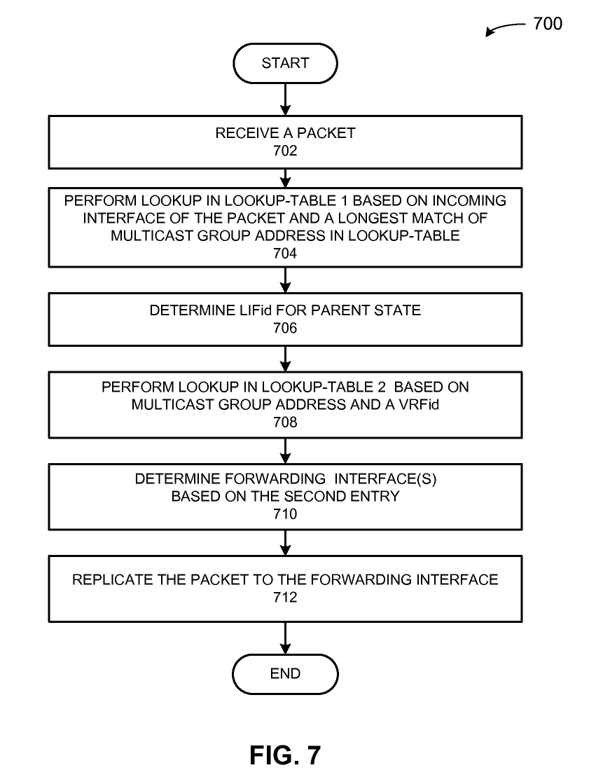

FIG. 7 presents a flow chart illustrating a process for forwarding a multicast packet in accordance with an embodiment. During operation, the router receives a multicast packet from a multicast source or another router (operation 702). The router then selects a first entry from lookup-table 1 based on the multicast address of the packet (which may or may not match one of the BIDIR ranges corresponding to different RP's) and the incoming interface on which the packet is received (operation 704). This lookup produces a LIFid which corresponds to the corresponding RP.

Recall that the LIFid is unique to the RP, and is used to map one or more accepting interface for an RP in lookup-table 1 to one or more multicast group addresses in lookup-table 2. Thus, the router determines the LIFid value for the parent state from the first entry (operation 706), and uses the multicast group address and a virtual routing and forwarding (VRF) ID to select a second entry from lookup-table 2 (operation 708). The second entry can include the LIFid for the child state, a source address, a multicast group address, and a pointer to one or more forwarding interfaces. In some embodiments, the router performs an RPF check by determining whether the LIFid value for the parent state matches the LIFid value for the child state. If these two LIFid values are the same, then the router determines that the RPF check is passed.

The router then uses the second entry to determine one or more forwarding interfaces for replicating and forwarding the packet (operation 710). For example, the router can use the second entry from lookup-table 2 to determine in the PRAM the forwarding interfaces associated with the multicast group address. Then, the router can replicate the data packet to these forwarding interfaces (operation 712). Note that the pointer to PRAM may indicate more than one forwarding interface. Furthermore, the replication does not occur unless the RPF check is passed.

### Source Port Suppression

In some embodiments, the router can perform an RPF check during operation 710 to prevent forwarding a data packet to a member of the multicast group from which the packet originated. For example, referring back to the example in FIG. 6, in network 600 router 608 receives a data packet from router 602 via accepting interface 634, and determines during operation 710 that it can send the packet to RP 610 and receiver 614 using interfaces 632, 634, and 636. However, to prevent propagating the data packet back to router 602, the router performs an RPF check to select the interfaces that it can propagate the packet through without sending the packet back to its source.

Source port suppression for non-bidirectional entries is performed by subtracting the RPF interface from the outgoing interface list before programming the list into hardware. However, a typical bidirectional child entry (*, g) can have multiple accepting interfaces inherited from the parent entry (*, g/m). If there are any overlaps between the accepting interface list and the forwarding interface list, the software cannot reduce the forwarding interface list accordingly, as the accepting interface is nondeterministic. Thus, to perform source port suppression for a bidirectional entry, the router can use the egress replacement table.

An entry in the replacement table includes egress VLAN tag information that the router uses to replicate a packet at the port level. These replacement table entries contain forwarding interface VLAN information. Also, to perform source-port suppression, the router can determine the packet's ingress port from the packet's header. Therefore, when replicating a data packet for entries of the replacement table (e.g., during operations 710 and 712 of FIG. 7), the router can perform the following RPF check against each replacement table entry to suppress the source-port:

If ((In_VLAN == REPLTBL_VLAN_ID) && (In_Port == DstPort))
Drop copy

If the RPF check fails for a bidirectional multicast entry, the router can drop the data packet.

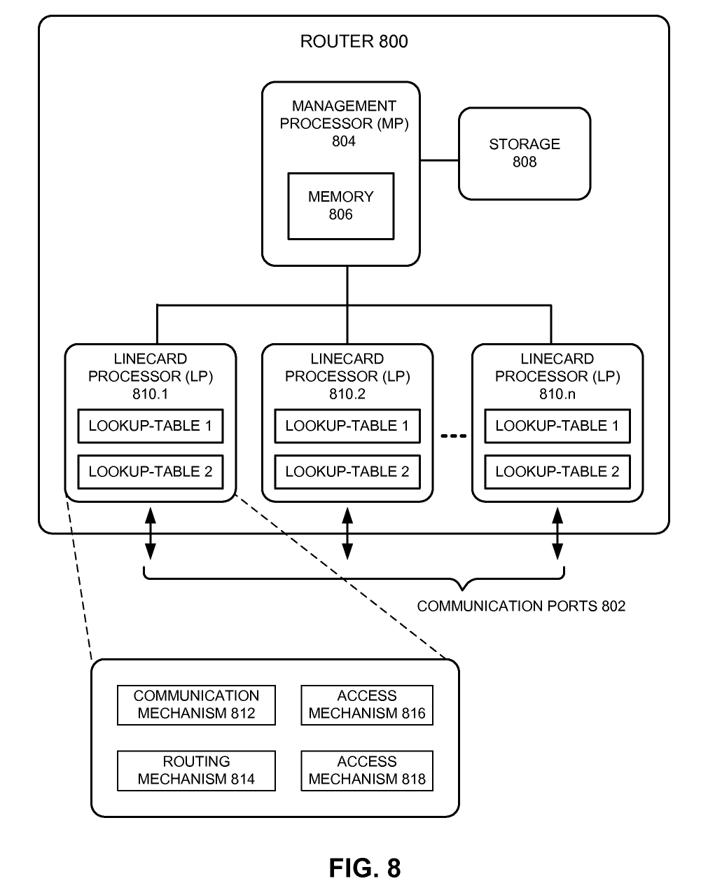

FIG. 8 illustrates an exemplary router architecture 800 in accordance with an embodiment. Router architecture 800 can include one or more communication ports 802, a management processor (MP) 804, a storage 808, and one or more linecard processors (LP) (e.g., LPs 810.1, 810.2, and 810.n). In some embodiments, storage 808 may include a non-volatile storage medium, such as a PRAM device. Also, MP 804 can include a memory 806 for storing data and/or instructions.

In some embodiments, MP 804 may store a logical interface (LIF) data structure (e.g., using an AVL tree data structure) in storage 808. The LIF data structure may associate a LIFid to one or more accepting interfaces for an RP (e.g., the DF winner and RPF interfaces for the RP). An entry in the LIF data structure can be searched by the LIFid, or can be searched by an RP's address.

In some embodiments, an LP (e.g., LP 810.1) can include a first lookup table (lookup-table 1) to store parent entries for an RP's multicast address range, and can include a second lookup table (lookup-table 2) to store child entries for a multicast group. Further, the LP can include a communication mechanism 812, a routing mechanism 814, an access mechanisms 816 that accesses lookup-table 1, and an access mechanism 818 that accesses lookup-table 2.

In some embodiments, MP 804 generates RP-specific routing state information when it detects an RP, and MP 804 provides this state information and a corresponding LIFid to LPs 810.1, 810.2, and 810.n. These LPs create one or more entries in their respective lookup-table 1 to store this routing state information and the LIFid. For example, when an LP receives the routing state information from the MP, the LP extracts parent entries and determines whether difference exists between the extracted parent entries and the parent entries stored in lookup-table 1. If difference exists, the LP stores the extracted parent entries in lookup-table 1.

In some embodiments, MP 804 generates group routing state information when it receives join messages for a multicast group, and MP 804 provides this group state information along with a corresponding LIFid to LPs 810.1, 810.2, and 810.n. These LPs then create one or more child entries in their respective lookup-table 2 to store the group state information and the LIFid.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A switching system, comprising:
a packet processor configured to identify a multicast address in a packet; and
a storage device coupled to the packet processor and storing:
a first table mapping a multicast group prefix and an accepting interface to a first logical reference; and
a second table mapping the first logical reference and a multicast group address to one or more forwarding interfaces.

2. The switching system of claim 1, further comprising a lookup mechanism coupled to the packet processor and the storage device, and configured to look up an entry in the first table based on an accepting interface corresponding to the packet.

3. The switching system of claim 1, further comprising a forwarding mechanism configured to determine whether the forwarding interface is the same as the accepting interface.

4. The switching system of claim 1, further comprising a forwarding mechanism configured to
select at least one destination address for the packet from a third table based on the group address.

5. The switching system of claim 1, wherein the storage device is further configured to insert an entry into the first table, and wherein the entry indicates routing state information of a rendezvous point (RP) and a second logical reference unique to the RP.

6. The switching system of claim 5, wherein the management mechanism is further configured to:
determine a reverse-path forwarding (RPF) interface for the RP.

7. The switching system of claim 1, further comprising a management mechanism configured to:
designate a routing node in the network as a designated-forwarder (DF) for an interface of the RP.

8. The switching system of claim 1, further comprising a management mechanism configured to store state information for the multicast group and the first logical reference.

9. A computer-implemented method, comprising:
identifying a multicast address in a packet;
determining a first entry in a first table, wherein the first entry maps a multicast group prefix and an accepting interface to a first logical reference;
determining a second entry in a second table, wherein the second entry maps the first logical reference and a multicast group address to one or more forwarding interfaces.

10. The method of claim 9, wherein determining the first entry involves performing a lookup in the first table based on an accepting interface corresponding to the packet.

11. The method of claim 9, further comprising:
determining whether the forwarding interface is the same as the accepting interface.

12. The method of claim 9, wherein determining the forwarding interface involves selecting at least one destination address for the packet from a third table based on the group address.

13. The method of claim 9, further comprising:
inserting a third entry into the first table, wherein the third entry indicates routing state information of a rendezvous point (RP) and a second logical reference unique to the RP.

14. The method of claim 13, further comprising:
determining a reverse-path forwarding (RPF) interface for the RP.

15. The method of claim 9, further comprising:
designating a routing node in the network as a designated-forwarder (DF) for an interface of the RP.

16. The method of claim 9, further comprising:
storing state information for the multicast group and the first logical reference.

17. A computer-readable storage medium storing instructions that when executed by a computer cause the computer to perform a method, the method comprising:
identifying a multicast address in a packet;
determining a first entry in a first table, wherein the first entry maps a multicast group prefix and an accepting interface to a first logical reference;
determining a second entry in a second table, wherein the second entry maps the first logical reference and a multicast group address to one or more forwarding interfaces.

18. The method of claim 17, wherein determining the first entry involves performing a lookup in the first table based on an accepting interface corresponding to the packet.

19. The method of claim 17, wherein the method further comprises determining whether the forwarding interface is the same as the accepting interface.

20. The method of claim 17, wherein determining the forwarding interface comprises:
selecting at least one destination address for the packet from a third table based on the group address.

21. The method of claim 17, wherein the method further comprises inserting a third entry into the first table, and wherein the third entry indicates routing state information of a rendezvous point (RP) and a second logical reference unique to the RP.

22. The method of claim 21, wherein the method further comprises:
determining a reverse-path forwarding (RPF) interface for the RP.

23. The method of claim 17, wherein the method further comprises:
designating a routing node in the network as a designated-forwarder (DF) for an interface of the RP.

24. The method of claim 17, wherein the method further comprises storing state information for the multicast group and the first logical reference.
